(19) United States
(12) Patent Application Publication
(10) Pub. No.: US 2016/0260197 A1
(43) Pub. Date: Sep. 8, 2016

(54) IMAGE PROCESSING APPARATUS AND IMAGE PROCESSING METHOD

(71) Applicant: Kabushiki Kaisha Toshiba, Tokyo (JP)

(72) Inventors: Ryuji HADA, Yokohama Kanagawa (JP); Yutaka OTA, Yokohama Kanagawa (JP)

(21) Appl. No.: 14/734,333

(22) Filed: Jun. 9, 2015

(30) Foreign Application Priority Data
Mar. 5, 2015 (JP) 2015-043903

(51) Int. Cl. G06T 3/40; G06T 5/00; H04N 5/907; H04N 5/345; H04N 9/64; H04N 5/374; H04N 9/04; H04N 1/60

(52) U.S. Cl. CPC G06T 3/4015; H04N 9/045; G06T 5/006; H04N 1/6008; H04N 5/345; H04N 9/646; H04N 5/374; H04N 5/907; G06T 2207/10024; G06T 2207/10004; H04N 2209/046

(57) ABSTRACT

According to embodiments, an image processing apparatus includes a line memory that holds one line of image signals, a line buffer that holds an image signal transferred from the line memory, and a signal processing section that generates an output image signal, the distortion of which is corrected, using the image signal stored in the line buffer, wherein the image signal and the output image signal are both RAW image signals, and the signal processing section subjects the image signal to demosaicking processing using a color component identical to the color component of an output pixel.

### CROSS-REFERENCE TO RELATED APPLICATION

This application is based upon and claims the benefit of priority from the Japanese Patent Application No. 2015-43903, filed on Mar. 5, 2015; the entire contents of which are incorporated herein by reference.

### FIELD

Embodiments described herein relate generally to an image processing apparatus and an image processing method.

### BACKGROUND

The images of objects obtained by image pickup apparatuses such as digital cameras picking up the images are typically influenced by distortion or chromatic aberration of magnification that optical systems such as image pickup lenses have. To suppress the distortion, the lenses are devised in material properties, or aspheric lenses are used, which however raises a problem of increasing design and manufacture costs. In addition, to suppress the chromatic aberration of magnification, a large number of sets of lenses having different refractive indices are used, which raises problems of increasing the number of lenses, increasing the apparatuses in size, and increasing manufacturing costs.

Thus, in recent years, as apparatuses by which these problems are solved, an image processing apparatus has been used that, if distortion or the like occurs in an image owing to distortion or chromatic aberration of magnification, electrically corrects the image with respect to the distortion occurring in an optical system.

In electrical correction processing performed in conventional image processing apparatuses, random access to an image is needed, and thus a method of holding one frame of an input image in a frame memory and accessing a necessary pixel each time is used. However, the frame memory has a large amount of memory, which disadvantageously increases manufacturing costs or increases the apparatus in size.

Thus, to reduce the amount of memory, an image processing apparatus has been proposed that uses a line memory instead of a frame memory. However, to correct the chromatic aberration of magnification, distortion correction for individual RGB colors is needed, and in the correction of an image generated by the image pickup device, demosaicking needs to be performed in advance. Installing line memories necessary to perform the correction of the chromatic aberration of magnification for respective colors raises a problem of increasing the usage of the line memories.

### BRIEF DESCRIPTION OF THE DRAWINGS

FIG. 1 is a schematic block diagram illustrating the configuration of an image processing apparatus in embodiments of the present invention;

FIG. 2 is a flowchart illustrating correction processing by a signal processing section 24 in a first embodiment;

FIG. 3 is a diagram illustrating an example of conversion from an output pixel Po into a reference pixel Pi;

FIG. 4 is a diagram illustrating an example of an access window Wa;

FIG. 5 is a diagram illustrating the colors of individual pixel values in a window Wi before and after partial demosaicking processing;

FIG. 6 is a diagram illustrating an access window addition region Wat in the case of subjecting adjoining pixels to parallel processing;

FIG. 7 is a diagram illustrating the access window addition region Wat in a second embodiment;

FIG. 8 is a flowchart illustrating correction processing by signal processing section 24 in the second embodiment;

FIG. 9 is a flowchart illustrating correction processing by the signal processing section 24 in a third embodiment; and

FIG. 10 is a flowchart illustrating correction processing by the signal processing section 24 in a fourth embodiment.

### DETAILED DESCRIPTION

An image processing apparatus of embodiments includes a line memory that holds one line of image signals, a line buffer that holds an image signal transferred from the line memory, and a signal processing section that generates an output image signal, the distortion of which is corrected, using the image signal stored in the line buffer, wherein the image signal and the output image signal are both RAW image signals, and the signal processing section subjects the image signal to demosaicking processing using a color component identical to the color component of an output pixel.

### EMBODIMENTS

Embodiments will be described below with reference to the drawings.

### First Embodiment

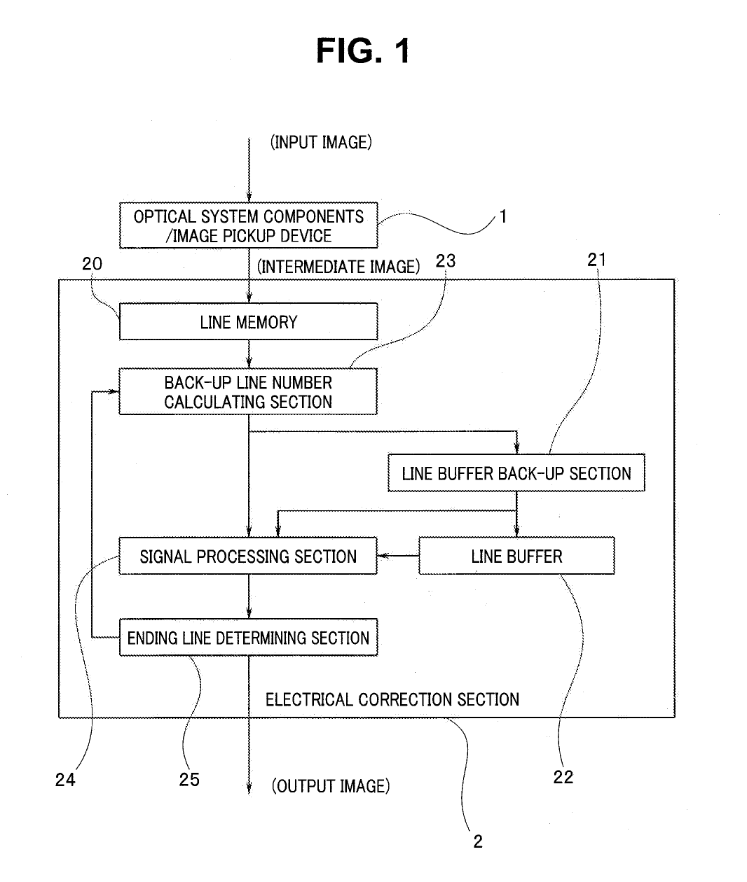

FIG. 1 is a schematic block diagram of an image processing apparatus in embodiments of the present invention. The image processing apparatus is mainly formed by an image picking up section 1 that picks up an image of an object and generates a digital image (intermediate image), and an electrical correction section 2 that subjects the intermediate image to electrical processing to correct distortion occurring in an optical system.

The image picking up section 1 is formed by an optical system component such as a taking lens, an image pickup device, an analog processing section, an A/D converting section, and the like. The optical system component forms the image of the object on a light receiving surface of the image pickup device. The image pickup device including a CCD image sensor, a CMOS sensor, or the like converts the formed image into electric signals (hereafter, referred to as image signals). The analog processing section, for example, adjusts the gain and reduces the noise components of the image signals, and generates analog image signals. The A/D converting section makes digital conversion of the analog image signals to generate a RAW image being the intermediate image. Note that, in the RAW image, a pixel value of one color is stored in one pixel based on a color filter array (e.g., the Bayer pattern) of the image pickup device.

The electrical correction section 2 is mainly formed by an input lime memory 20, a line buffer back-up section 21, a line buffer 22, a back-up line number calculating section 23, a signal processing section 24, and an ending line determining section 25. In addition, the electrical correction section 2 also has an output line memory (not shown). The output line memory holds one line of output image signals from the signal processing section 24.

The input lime memory 20 holds one line of intermediate image signals that are inputted from the image picking up section 1. The line buffer back-up section 21 has a buffer that can hold image signals of a certain number of lines (e.g., about 32 lines) (hereafter, referred to as an input back-up buffer). The input back-up buffer is supplied from the line memory 20 with one line of intermediate image signals regularly for each time. When the input back-up buffer already holds image signals to full capacity, one line of image signals that have been stored in the forefront is first discarded from among image signals that have already been stored.

The line buffer 22 holds intermediate image signals relating to a line that may be used for correction. The line buffer 22 is also formed, as with the input back-up buffer, by a buffer that can hold image signals of a certain number of lines (e.g., about 32 lines). In the line buffer 22, there must be intermediate image signals stored that are to be needed for correction processing to acquire image signals of a line to be outputted next. The intermediate image signals for the processing are not identical to the intermediate image signals stored in the input back-up buffer. Therefore, intermediate image signals need to be read from the input back-up buffer as appropriate to update the line buffer 22.

The number of back-up lines necessary for the update (the number of lines of intermediate image signals to be transferred from the input back-up buffer to the line buffer 22) is calculated by the back-up line number calculating section 23. The back-up line number calculating section 23 calculates the ranges of lines of intermediate image signals that are to be needed for the correction processing performed by the signal processing section 24. Then, out of image signals within the range, the intermediate image signals of lines that are not stored in the line buffer 22 are cause to be read from the line buffer back-up section 21 into the line buffer 22.

The signal processing section 24 is an optical correction circuit that specifies, for each pixel in the output image signals, the pixel position in the corresponding intermediate image signal and performs the correction processing on the pixel value. Note that an output image resulting from the correction processing is a RAW image.

The ending line determining section 25 determines whether output image signals stored in the output line memory are of the ending line of a processing object frame. If the output image signals are of the ending line, which means that the correction processing for one frame has been completed, intermediate image signals stored in the input back-up buffer and the line buffer 22 are discarded. In addition, the ending line determining section 25 notifies the back-up line number calculating section 23 that a line to be outputted next is the first line (in the next frame).

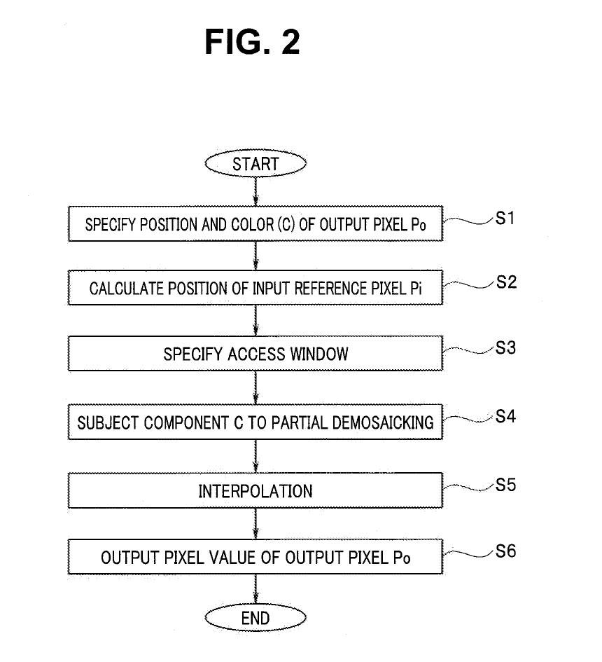

Next, the procedure in the signal processing section 24 for correcting an intermediate image signal and calculating a pixel value in an output image will be described. FIG. 2 is a flowchart illustrating the correction processing by the signal processing section 24 in the first embodiment.

First, the signal processing section 24 specifies the pixel position (ho,vo) of an output pixel Po to be a correction object (hereafter, denoted as a pixel Po(ho,vo)). In addition, since the output image is a RAW image, the signal processing section 24 also specifies a color (C) in the pixel position (S1). The color C is determined based on the color filter array of the image pickup device. For example, the determination is made in such a manner that C=G if (ho=0,vo=0), C=R if (ho=1,vo=0), and C=B if (ho=0,vo=1).

Next, the signal processing section 24 converts the output pixel Po(ho,vo) into the pixel position (hi,vi) of a reference pixel Pi in the intermediate image (hereafter, denoted as a pixel Pi(hi,vi)) (S2). The conversion of the pixel position is made using Equations (1) to (3) as shown below.

hi=(k0+k1*r2+k2*r2̂2+k3*r2̂3+k4*r2̂4)*ho Equation (1)

vi=(k0+k1*r2+k2*r2̂2+k3*r2̂3+k4*r2̂4)*vo Equation (2)

r2=ho*ho+vo*vo Equation (3)

In Equations (1) and (2), kx (x=0 to 4) are correction parameters determined according to the color (RBG) (distortion correction coefficients). In addition, the output pixel Po(ho,vo) is coordinates, the origin of which is the center of the output image, and the reference pixel Pi(hi,vi) is coordinates, the origin of which is the center of the intermediate image. Note that both the coordinates define the right side as a positive side in the horizontal direction and the lower side as a positive side in the vertical direction.

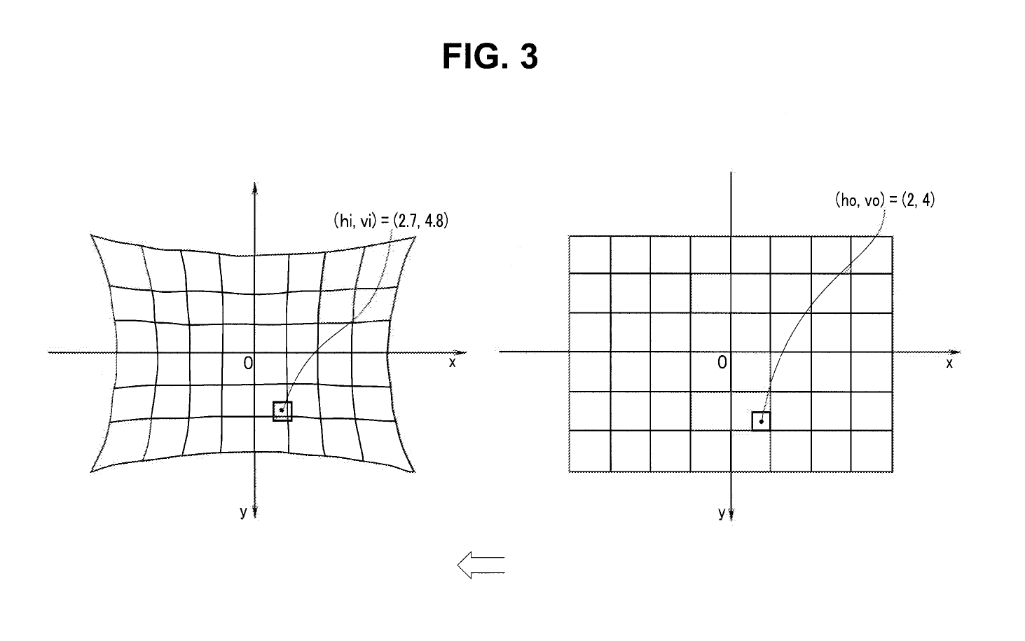

While the position coordinates (ho,vo) of the output pixel Po are both integers, the position coordinates (hi,vi) of the reference pixel Pi are normally decimal numbers. FIG. 3 is a diagram illustrating an example of conversion from an output image to an intermediate image. For example, in the case of an output pixel Po(2,4), the calculation is made in such a manner as to result in a reference pixel Pi(2.7,4.8). Accordingly, the pixel value of the output pixel Po is interpolated using the pixel values of nearby pixels around the reference pixel Pi.

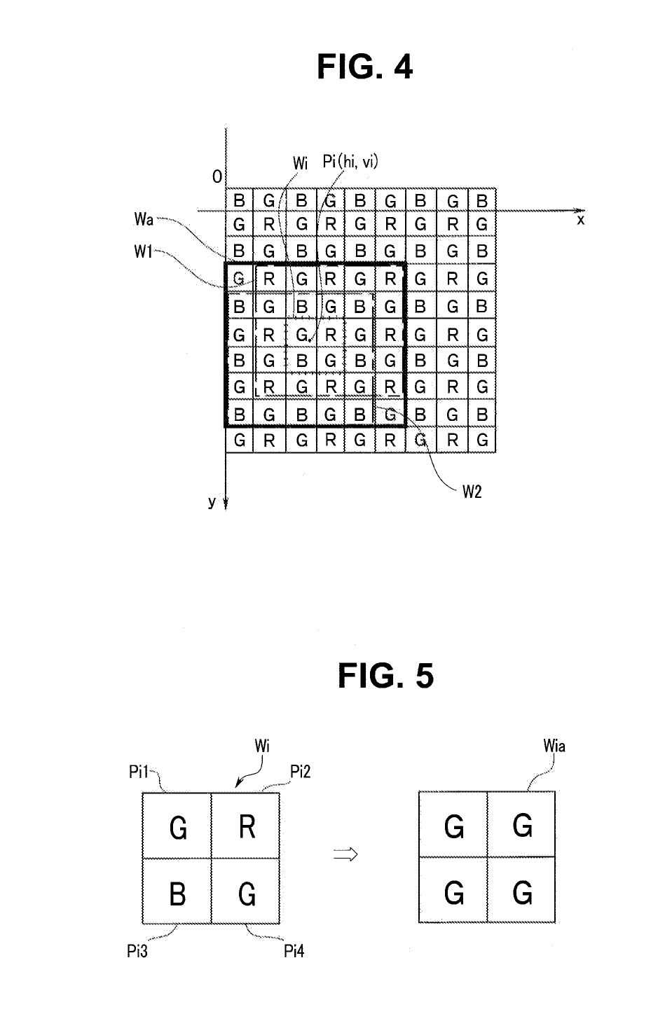

Next, the signal processing section 24 specifies a pixel region of the intermediate image signal necessary for the interpolation of the pixel value (hereafter, referred to as an access window Wa) (S3). FIG. 4 is a diagram illustrating an example of the access window Wa. The pixel region necessary for the interpolation differs depending on an interpolation method of the pixel value, and thus the interpolation method of the pixel value is first determined. The interpolation method of the pixel value is not limited to a specific method and an appropriate method can be selected from among existing interpolation methods (bilinear interpolation, bicubic interpolation, nearest neighbor interpolation, and the like). For example, in the case of the bilinear interpolation, the interpolation is performed using 2×2 pixels (=four pixels) around the reference pixel Pi(2.7,4.8). More specifically, the interpolation is performed using the four pixels of Pi1(2,4), Pi2(3,4), Pi3(2,5), and Pi4(3,5). A pixel region necessary for the above-described interpolation (the bilinear interpolation in this case) will be hereafter referred to as a window Wi.

The interpolation is made using the pixel values of the color components of the four pixels, which are the same color component as the output pixel Po. However, since the intermediate image is a RAW image, the pixel value of only one color is stored for one pixel based on the color filter array of the image pickup device. For example, in the case of a Bayer pattern, the colors of Pi1(2,4) and Pi4(3,5) are G as shown in FIG. 4, and thus the intermediate image signals of the pixels stored in the line buffer 22 can be used as it is. However, the color of Pi2(3,4) is R and the color of Pi3(2,5) is B, and thus, as to the two pixels, the intermediate image signals of the pixels stored in the line buffer 22 cannot be used as it is. Therefore, for the two pixels that do not have the G component, the G component is calculated by demosaicking. Demosaicking processing in which only a pixel signal of a specific color component is calculated will be hereafter referred to as partial demosaicking.

The demosaicking is processing in which color information that an object pixel does not have is interpolated using pieces of color information of pixels in a surrounding region. The demosaicking is not limited to a specific method and can be performed using an appropriate method from among known methods. For example, when the G component of the object pixel is calculated using the G components of 5×5 pixels, the center of which is the object pixel, the partial demosaicking of the Pi2(3,4) is performed using the pixel values of pixels positioned in a region (the window W1), the four corners of which are (hi,vi)=(1,2)(5,2)(1,6)(5,6), in order to calculate the G component. In addition, the partial demosaicking of the Pi3(2,5) is performed using the pixel values of pixels positioned in a region (a window W2), the four corners of which are (hi,vi)=(0,3)(4,3)(0,7)(4,7), in order to calculate the G component.

The access window Wa is a region that is referred to for both the partial demosaicking and the bilinear interpolation, and thus a region including three windows Wi, W1, and W2. Accordingly, in the case of the above-described example, the access window Wa is specified as a region having 6×6 pixels, the four corners of which are (hi,vi)=(0,3)(5,3)(0,7)(5,7).

Next, the signal processing section 24 accesses image signals in the access window Wa among the image signals stored in the line buffer 22. The signal processing section 24 then calculates, by the partial demosaicking, the pixel values of the G component for the pixels Pi2(3,4) and Pi3(2,5) that have no pixel values of the G component among the pixels Pi1 (2,4), Pi2(3,4), Pi3(2,5), and Pi4(3,5) present in the window Wi that is a pixel region necessary for the interpolation (S4). FIG. 5 is a diagram illustrating the colors of individual pixel values in the window Wi before and after the partial demosaicking. By the partial demosaicking, the pixel values of the G component can be acquired for all the four pixels in the window Wi.

Subsequently, the signal processing section 24 performs the interpolation using the pixels in the window Wi and calculates the pixel value of the G component for the reference pixel Pi(hi,vi=2.7,4.8) (S5).

Lastly, the signal processing section 24 outputs the pixel value of the G component for the reference pixel Pi as the pixel value of the output pixel Po (S6). In the present embodiment, since the output image generated through the correction by the electrical correction section 2 is a RAW image, the output pixel has only the pixel value of one color for one pixel. Accordingly, the series of processing is finished by outputting the pixel value of the G component for the output pixel Po.

As seen from the above, according to the present embodiment, a RAW image is stored in the line buffer 22 as a correction object image. Accordingly, the usage of the line buffer 22 can be reduced as compared with the case of using an image subjected to color separation (RGB image) as a correction object. For example, assume that the resolution of an intermediate image is 4000×3000 pixels, the amount of distortion is 2%, RAW pixel data is of 10 bits, and RGB pixel data after the demosaicking is of 8 bits. With a conventional image processing apparatus, the usage is 3000×2%×4000×3×8 bits=5760 Kbits=720 Kbytes. In contrast, in the case of the present embodiment, the usage is 3000×2%×4000×10 bits=2400 Kbits =300 Kbytes. As compared with the conventional image processing apparatus, the present embodiment can reduce the usage of the line buffer 22 by more than half.

Note that when the image signals in the access window Wa are referred to in the partial demosaicking and the correction processing, the signal processing section 24 may directly access the line buffer 22 each time or may access a buffer that is separately provided, the buffer holding the image signals of pixels in the access window Wa.

In addition, configurations and methods for supplying intermediate image signals from the line memory 20 to the line buffer 22 are not limited to the above-described configuration and method. That is, any configuration and method can be used as long as the configuration and method supplies intermediate image signals from the line memory 20 to the line buffer 22 such that the image signals in the access window Wa necessary for the correction of the output pixel Po being a processing object are stored in the line buffer 22.

Furthermore, to secure the throughput of image processing, a design in the implementation of an LSI is desirably developed in such a manner that the access window Wa can be acquired from the line buffer 22 at certain cycles (e.g., one cycle).

In addition, the number of the line buffers 22 is not limited to one, and may be multiplexed, in the implementation of the LSI, in such a manner that, for example, the line buffers 22 are allocated for the right and left halves of an image, respectively. Multiplexing the line buffer 22 enables the enhanced speed of the image processing.

### Second Embodiment

In the image processing apparatus in the first embodiment, the output pixels are subjected to the correction processing one by one. In contrast, a second embodiment differs in that a plurality of pixels are subjected to the correction processing in parallel. An image processing apparatus in the second embodiment has a configuration similar to that in the first embodiment. A correcting method of intermediate image signals in the signal processing section 24 will be described below. Note that the description will be made below with the case where two pixels are corrected in parallel.

The pixel values of an output image outputted from the electrical correction section 2 are normally calculated on a pixel-to-pixel basis in an outputting order. That is, the pixel values are calculated on a line-to-line basis from the uppermost line to the lowermost line of the output image, and pixel values in each line are calculated on a pixel-to-pixel basis from the leftmost pixel to the rightmost pixel. In the case where the color filter of the image pickup device has the Bayer pattern, the color components of the output pixels vary like G→R→G→R→ . . . →R→B→G→B→ . . . .

Since the distortion correction coefficients vary depending on colors, the position of the reference pixel Pi differs depending on the color component of the output pixel Po. A major chromatic aberration of magnification causes the distortion correction coefficients to vary significantly among the individual colors. In such a case, even from adjoining output pixels, the respective reference pixels are at separated positions if the color components are different from each other.

As describe in the first embodiment, the pixel value of the output pixel Po is calculated using the pixel values in the neighbor region (the access window Wa) of the reference pixel Pi. In the case where a plurality of output pixels Po1 and Po2 are processed in parallel, it is necessary to access both the access windows Wa1 and Wa2 that are obtained from the reference pixels Pi1 and Pi2 for the respective output pixels, at certain cycles (e.g., one cycle) that is the same as the case of the processing not in parallel. A region including both the access windows Wa1 and Wa2 will be referred below to as an access window addition region Wat.

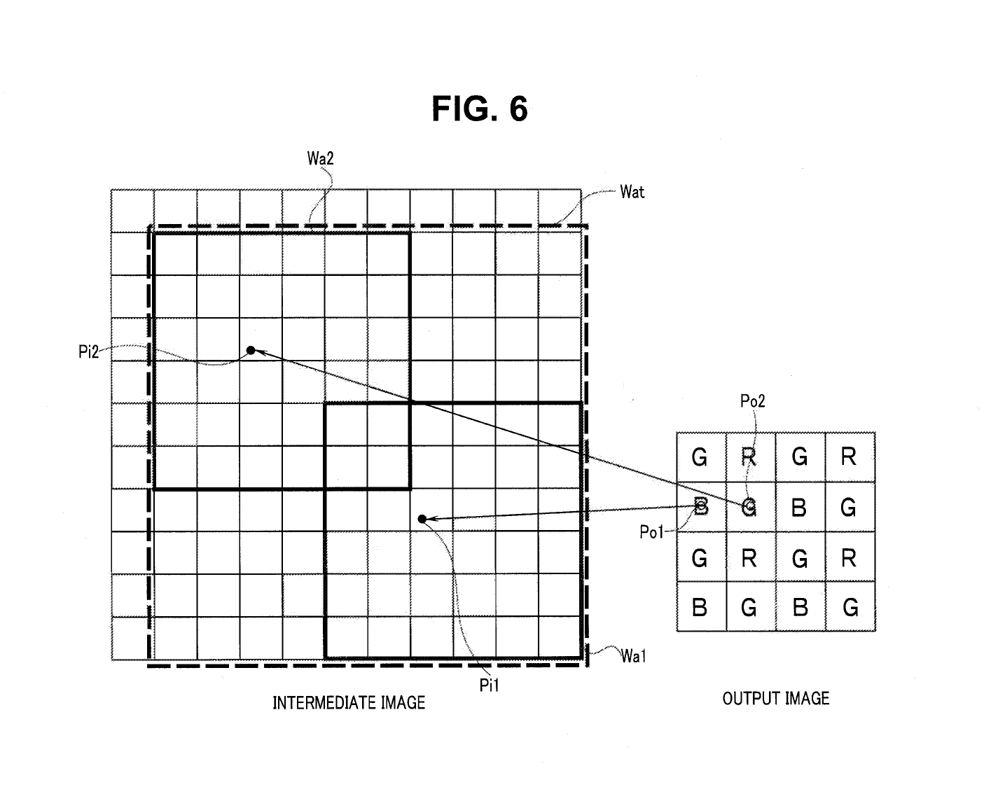

FIG. 6 is a diagram illustrating the access window addition region Wat in the case where adjoining pixels are subjected to parallel processing. The color components of the adjoining output pixels Po1 and Po2 are different from each other. In the example shown in FIG. 6, the output pixel Po1 has the B component, and the output pixel Po2 has the G component. Since a major chromatic aberration of magnification causes the distortion correction coefficients to vary significantly between the B component and the G component, the reference pixels Pi1 and Pi2 are positioned at a distance. Accordingly, the access window addition region Wat is enlarged.

In FIG. 6, the reference pixel Pi1 and the reference pixel Pi2 are positioned at a distance of four pixels in a vertical direction and four pixels in a horizontal direction. Assuming that the access windows Wa1 and Wa2 are 6×6 pixel regions including the reference pixels Pi1 and Pi2, respectively, the access window addition region Wat is a 10×10 pixel region. Such a large access window addition region Wat requires the line buffer 22 to have a large bandwidth in the implementation of the LSI, leading to the increase of costs.

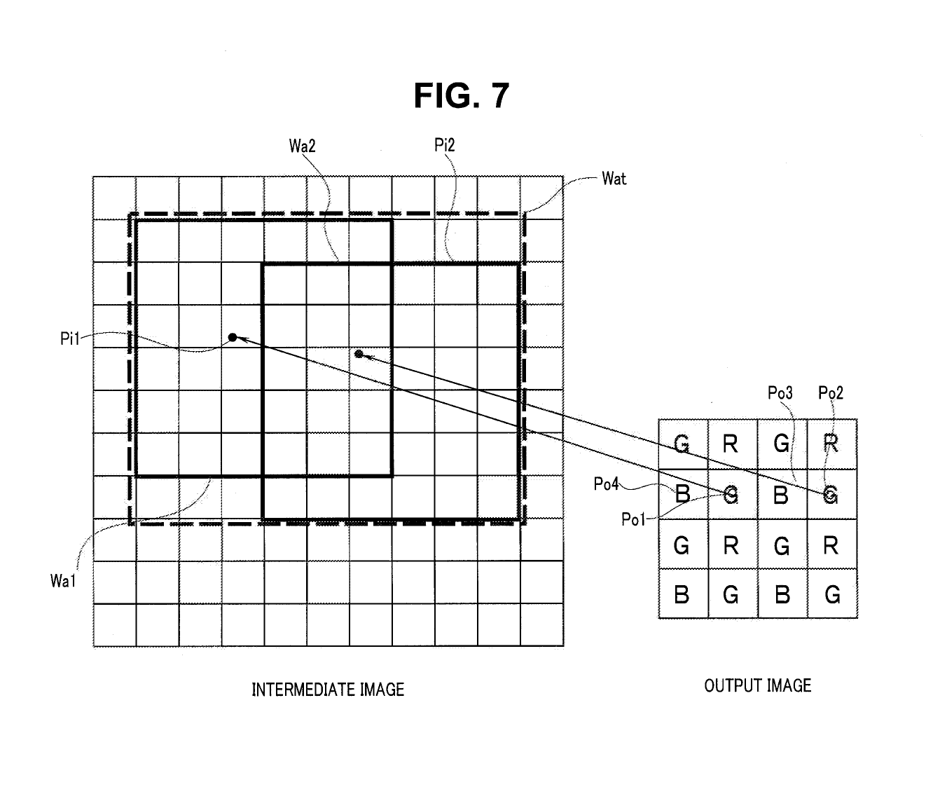

In contrast, in the present embodiment, the parallel processing is performed in such a manner as to change the order of calculation of the output pixels that are positioned close to each other and have the same color component. FIG. 7 is a diagram illustrating the access window addition region Wat in the second embodiment. In the present embodiment, two output pixels Po1 and Po2 that have the same color component and are positioned close to each other are subjected to the parallel processing. In the example shown in FIG. 7, the output pixels Po1 and Po2 both have the G component. In addition, the output pixel Po1 and the output pixel Po2 are positioned in the same line, adjoining across an output pixel having the B component. In this case, regardless of whether the chromatic aberration of magnification is major or minor, the reference pixels Pi1 and Pi2 are to be positioned close to each other. Accordingly, the access window addition region Wat can be narrowed down as compared with the case where adjoining pixels are subjected to the parallel processing.

In FIG. 7, the reference pixel Pi1 and the reference pixel Pi2 are positioned at a distance of one pixel in a vertical direction and three pixels in a horizontal direction. The access windows Wa1 and Wa2 are the 6×6 pixel regions including the reference pixels Pi1 and Pi2, respectively. In this case, the access window addition region Wat is a 9×7 pixel region.

Note that the access window addition region Wat is calculated prior to the correction processing in the signal processing section 24. The line buffer 22 is updated as required such that image signals in the access window addition region Wat necessary for calculating the output pixels Po1 and Po2 are stored.

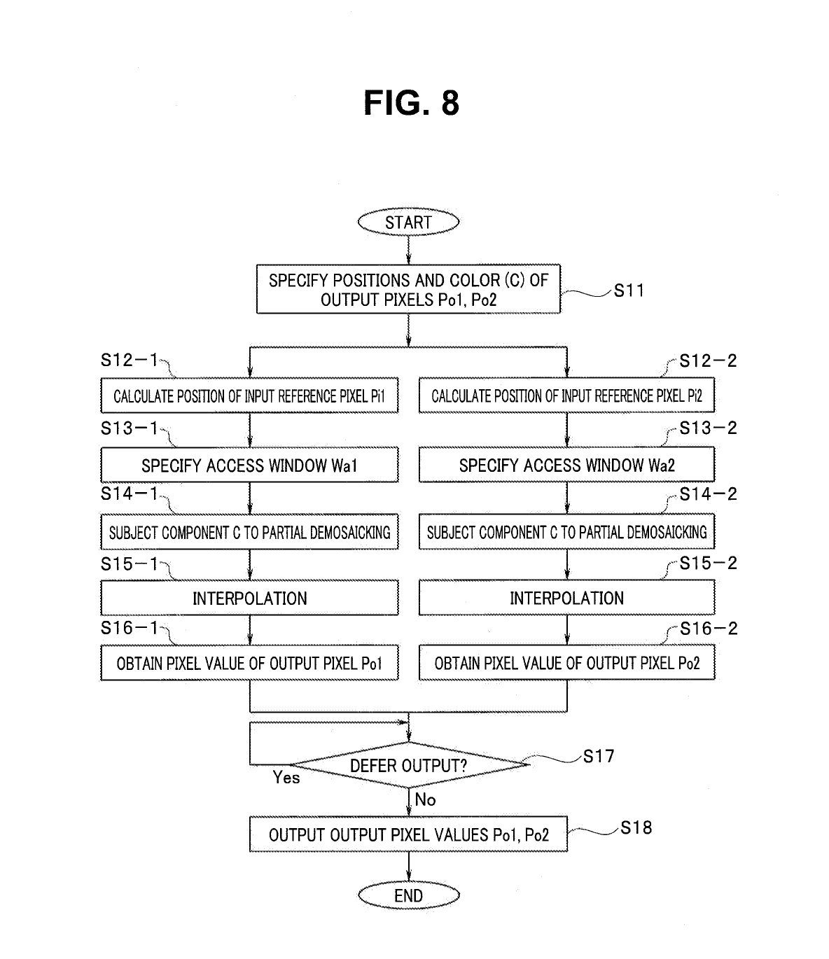

FIG. 8 is a flowchart illustrating the correction processing by the signal processing section 24 in the second embodiment. First, the signal processing section 24 specifies output pixels Po1(ho1,vo1) and Po2(ho2,vo2) to be subjected to the parallel processing. In addition, the signal processing section 24 also specifies the color (C) of the output pixels Po1 and Po2 (S11). As the output pixels Po1 and Po2, output pixels that are positioned close to each other and have the same color component are selected. In the example of FIG. 7, two output pixels having the G component that are positioned in the same line across one output pixel having the B component are specified as the output pixels Po1 and Po2. Accordingly, the pixel position of the output pixel Po2 can be expressed as (ho1+2,vo1).

Next, the signal processing section 24 calculates the pixel values of the output pixels Po1 and Po2, as with the first embodiment (S12 to S16). At this point, the respective pixel values of the output pixels Po1 and Po2 are calculated through concurrent processing. That is, the following procedure is performed for the output pixel Po1. First, the signal processing section 24 converts the output pixel Po1(ho1,vo1) into the reference pixel Pi1(hi1,vi1) using the correction equations (1) to (3) (S12-1). The signal processing section 24 then specifies the access window Wa1 (S13-1). The signal processing section 24 calculates the pixel value of the color component with the partial demosaicking for pixels, in the access window Wa1, that do not have the same color component as the output pixel Po1 (S14-1). The signal processing section 24 then interpolates the pixel value to calculate the pixel value of the G component of the reference pixel Pi1 (S15-1). Lastly, the signal processing section 24 acquires the pixel value of the calculated reference pixel Pi1 as the pixel value of the output pixel Po1 (S16-1).

For the output pixel Po2, the signal processing section 24 similarly converts the output pixel Po2(ho2,vo2) into the reference pixel Pi2(hi2,vi2) using the correction equations (1) to (3) (S12-2). The signal processing section 24 specifies the access window Wa2 (S13-2). The signal processing section 24 then calculates the pixel value of the color component with the partial demosaicking for pixels, in the access window Wa2, that do not have the same color component as output pixel Po2 (S14-2). The signal processing section 24 interpolates the pixel value to calculate the pixel value of the G component of the reference pixel Pi2 (S15-2). Lastly, the signal processing section 24 acquires the pixel value of the calculated reference pixel Pi2 as the pixel value of the output pixel Po2 (S16-2).

Subsequently, the signal processing section 24 determines whether to perform or defer the output of the pixel values of the output pixels Po1 and Po2 (S17). The pixel values of the output image are typically outputted in an arranged order from a pixel positioned at the left end to the right end in the same line. However, in the present embodiment, the pixel values are calculated in an order different from the outputting order. Accordingly, the acquired pixel values need to be outputted after rearranged. In the case of FIG. 7, the output pixel Po3 having the B component is sandwiched between the output pixel Po1 and the output pixel Po2. Accordingly, for the output pixel Po2, the output of the pixel value needs to be deferred until the pixel value of the output pixel Po3 is acquired and outputted.

Accordingly, in the case where the pixel value of the first pixel previous to the pixel in the outputting order has been outputted or the pixel value has been acquired and ready to be outputted, the signal processing section 24 does not defer the output of the pixel value of the pixel (S17, No), but outputs the pixel value straightly (S18). In contrast, in the case where a pixel value of the first pixel one pixel before in the outputting order has not been acquired, the signal processing section 24 defers the output of the pixel value of the pixel until the pixel value of the first pixel previous to the pixel in the outputting order is acquired or outputted (S17, Yes).

A case where, for example, the output pixels are outputted in an order of Po4→Po1→Po3→Po2 will be described. If the output pixel Po4 has been outputted immediately previously, the output pixel Po1 is subsequently outputted. If the output pixel Po4 has been acquired and the output thereof is deferred, the output pixels are outputted in an order of Po4→Po1. If the output pixel Po4 has not been acquired, the output of the output pixel Po1 is deferred. If the output pixel Po3 has been acquired and the output thereof is deferred, the output pixels are outputted in an order of Po1→Po3→Po2. If the output pixel Po3 has not been acquired, the output of the output pixel Po2 is deferred. In such a manner, the acquired pixel values are sorted into the outputting order and outputted, and the signal processing section 24 finishes the series of processing.

It is thereby possible to suppress the increment of the region of the reference pixels (the access window Wa) when the correction processing is performed on the pixels in the region of the reference pixel (the access window addition region Wat) one by one. Accordingly, the enlargement of the bandwidth of the line buffer 22 can be suppressed, enabling the enhancement of the speed while suppressing the increase of costs.

### Third Embodiment

In the image processing apparatuses in the first and second embodiments, the correction processing of the distortion is performed without taking into consideration the influence of the mixture of pixel colors (crosstalk) in a sensor. For this reason, if the crosstalk has a great influence, the phenomenon of color shift may occur in an image after color matrix processing (processing of correcting the mixture of pixel color by separating RGB components). This is caused by performing the color matrix processing on a pixel different from a proper correction object of the mixture of pixel color owing to pixel movement in distortion correction processing.

Thus, in a third embodiment, pixels in a neighbor region (the window Wi) are subjected to the partial demosaicking processing after white balance processing and color matrix processing are performed. An image processing apparatus in the third embodiment has a configuration similar to that in the first embodiment. A correcting method of intermediate image signals in the signal processing section 24 will be described below.

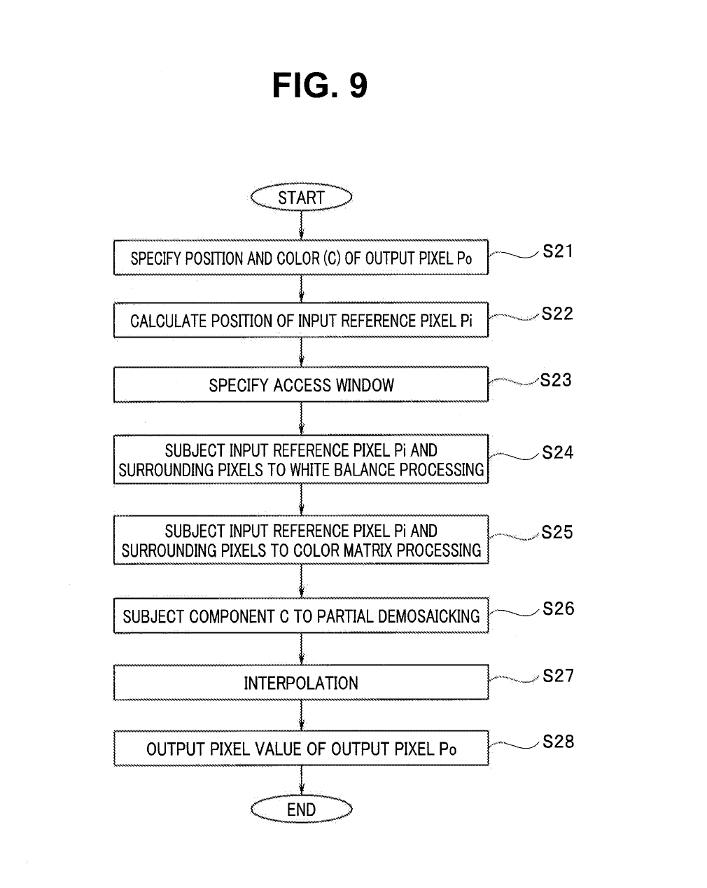

FIG. 9 is a flowchart illustrating the correction processing by the signal processing section 24 in the third embodiment. First, the signal processing section 24 specifies the output pixel Po(ho,vo) and the color (C) (S21). The color C is determined based on the color filter array of the image pickup device. Next, the signal processing section 24 converts the output pixel Po(ho,vo) into the reference pixel Pi(hi,vi) (S22). The signal processing section 24 specifies a pixel region of the intermediate image signals (the surrounding region of the reference pixel Pi, the access window Wa) (S23). Note that a series of processing from S21 to S23 is similar to processing from S1 to S3 in FIG. 2.

Subsequently, the signal processing section 24 subjects the pixels in the neighbor region (the pixels in the window Wi) to the white balance processing (S24). A white balance coefficient is calculated from the pixel values in the entire image region. Accordingly, a hardware configuration having no frame, like the image processing apparatus in the present embodiment, uses the white balance coefficient that is calculated using an output image one frame before. Note that the white balance coefficient differs depending on colors.

In addition, prior to the white balance processing, demosaicking conversion is performed on the pixels in the window Wi to generate all pieces of color information (pixel values) on the respective pixels.

Next, the signal processing section 24 performs color matrix processing on the pixels that have been subjected to the white balance processing (S25).

The white balance coefficients of the pixels having the individual colors are denoted by wr, wg, and wb, and color matrix coefficients are defined as Equation (4).

$$color matrix coefficients = ( \begin{matrix}r 0 & r 1 & r 2 \\ g 0 & g 1 & g 2 \\ b 0 & b 1 & b 2\end{matrix} ) \qquad Equation ( 4 )$$

In addition, the demosaicking conversion of a pixel having the R component is denoted by fr(R,G,B), the demosaicking conversion of a pixel having the G component is denoted by fg(R,G,B), the demosaicking conversion of the a pixel having the B component is denoted by fb(R,G,B). In this case, a pixel subjected to the white balance processing and the color matrix processing is expressed as Equation (5) if having the R component, Equation (6) if having the G component, or Equation (7) if having the B component.

$$\begin{matrix}Pi ( h , v ) = r 0 * fr ( wr * R ( h , v ) , wg * G ( h , v ) , wb * B ( h , v ) ) + r 1 * fg ( wr * R ( h , v ) , wg * G ( h , v ) , wb * B ( h , v ) ) + r 2 * fb ( wr * R ( h , v ) , wg * G ( h , v ) , wb * B ( h , v ) ) & Equation ( 5 ) \\ Pi ( h , v ) = g 0 * fr ( wr * R ( h , v ) , wg * G ( h , v ) , wb * B ( h , v ) ) + g 1 * fg ( wr * R ( h , v ) , wg * G ( h , v ) , wb * B ( h , v ) ) + g 2 * fb ( wr * R ( h , v ) , wg * G ( h , v ) , wb * B ( h , v ) ) & Equation ( 6 ) \\ Pi ( h , v ) = b 0 * fr ( wr * R ( h , v ) , wg * G ( h , v ) , wb * B ( h , v ) ) + b 1 * fg ( wr * R ( h , v ) , wg * G ( h , v ) , wb * B ( h , v ) ) + b 2 * fb ( wr * R ( h , v ) , wg * G ( h , v ) , wb * B ( h , v ) ) & Equation ( 7 )\end{matrix}$$

The subsequent processing is performed using the pixels in the window Wi that have been subjected to the white balance processing and the color matrix processing. The signal processing section 24 calculates, among the pixels in the pixel region necessary for the interpolation of the reference pixel Pi, the color components of pixels not having the pixel value of the color C of the output pixel Po with the partial demosaicking (S26). Pixels to be used in the partial demosaicking are pixels in the access window Wa. Subsequently, the signal processing section 24 calculates the pixel value of the color C of the reference pixel Pi (S27). Lastly, the signal processing section 24 outputs the pixel value of the color C of the reference pixel Pi as the pixel value of the output pixel Po (S28). Note that a series of processing from S26 to S28 is similar to processing from S4 to S6 in FIG. 2.

As seen from the above, in the present embodiment, the pixels in the neighbor region (the pixels in the window Wi) are subjected to the white balance processing and the color matrix processing, and thereafter the pixel value of the reference pixel Pi is interpolated. It is thereby possible to perform the correction using pixel values from which the influence of the crosstalk is eliminated, enabling the suppression of the color shift of the output image.

### Fourth Embodiment

In the image processing apparatus in the third embodiment, the distortion correction is performed using pixels that have been subjected to the white balance processing and the color matrix processing, and the pixel value of each pixel in an output image is calculated. However, since the output image after the distortion correction is a RAW image, white balance processing and color balance adjustment may be optionally performed in RAW development processing. Thus, in a fourth embodiment, the reference pixel Pi after the distortion correction processing is subjected to processing of cancelling the effects of the white balance processing and the color matrix processing to calculate the pixel value of the output pixel Po.

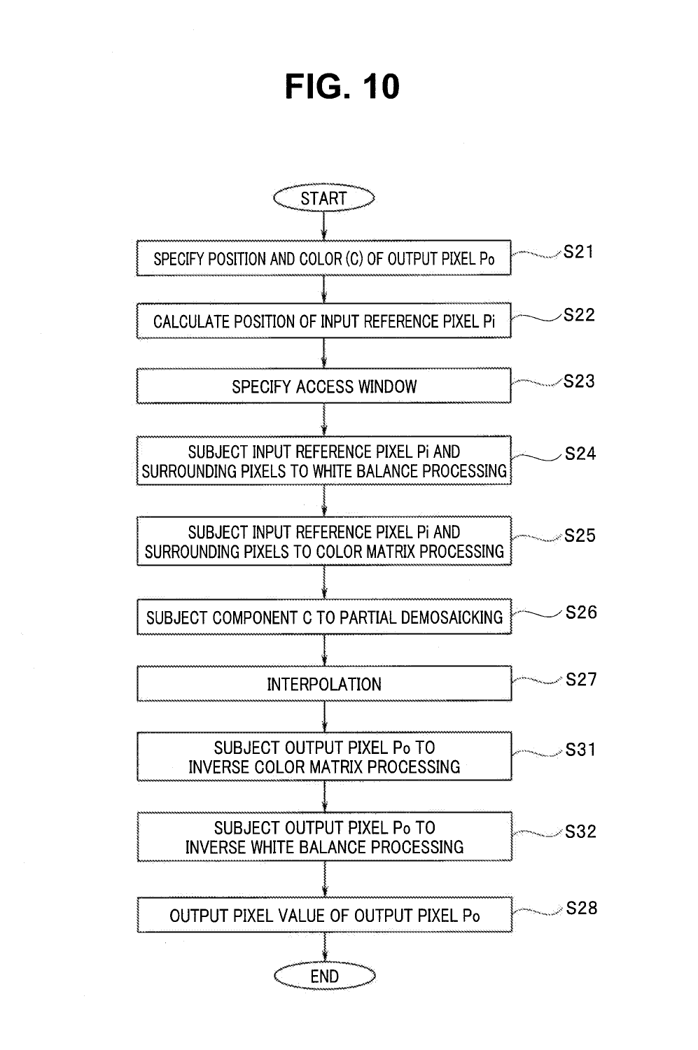

The image processing apparatus in the fourth embodiment has a configuration similar to that in the first embodiment. The correcting method of intermediate image signals in the signal processing section 24 will be described below. FIG. 10 is a flowchart illustrating signal correction processing by the signal processing section 24 in the fourth embodiment. The procedure from S21 to S27 in FIG. 10 is similar to the processing from S21 to S27 in FIG. 9.

Next, the signal processing section 24 performs inverse color matrix processing by multiplying the pixel value of the color C of the reference pixel Pi after the distortion correction processing by the inverse matrix of the color matrix coefficients that is used in the color matrix processing of S25 (S31). Subsequently, the signal processing section 24 performs inverse white balance processing by multiplying the pixel value after the inverse color matrix processing by the inverse number of the white balance coefficient (S32). Lastly, the signal processing section 24 outputs the pixel value of the color C of the reference pixel Pi that has been subjected to the inverse color matrix processing and the inverse white balance processing, as the pixel value of the output pixel Po (S28).

As seen from the above, in the present embodiment, the processing of cancelling the effects of the white balance processing and the color matrix processing that are performed in the distortion correction processing at the time of calculating the output pixel Po is performed. It is thereby possible to perform processing similar to conventional one when the white balance processing and the color balance adjustment are optionally performed in the RAW development processing, enabling the suppression of increasing the complexity of the processing.

The individual sections in the present specification are those that are conceptual and correspond to the respective functions in the embodiments, and do not necessarily correspond to specific pieces of hardware or software routines one to one. Accordingly, in the present specification, the embodiments are described postulating virtual circuit blocks (sections) having the respective functions in the embodiments.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. An image processing apparatus comprising:
a line memory that holds one line of image signals;
a line buffer that holds an image signal transferred from the line memory; and
a signal processing section that generates an output image signal, distortion of which is corrected, using the image signal stored in the line buffer, wherein
the image signal and the output image signal are both RAW image signals, and the signal processing section subjects the image signal to demosaicking processing using a color component of an output pixel.

2. The image processing apparatus according to claim 1, wherein the signal processing section performs correction of the distortion on the output pixel in plurality in parallel, and the output pixel in plurality is adjoining pixels that have an identical color component.

3. The image processing apparatus according to claim 1, wherein the signal processing section performs white balance processing and color matrix processing for each pixel of the image signal.

4. The image processing apparatus according to claim 3, wherein the signal processing section performs inverse white balance processing and inverse color matrix processing to the image signal subject to the demosaicking processing.

5. The image processing apparatus according to claim 1, wherein the signal processing section performs correction of the distortion by bilinear interpolation.

6. The image processing apparatus according to claim 2, wherein the signal processing section acquires pixel values to calculate the output pixel in plurality from the line buffer at an identical cycle.

7. The image processing apparatus according to claim 2, wherein the signal processing section subjects the image signal to white balance processing and color matrix processing for each pixel.

8. The image processing apparatus according to claim 7, wherein the signal processing section performs inverse white balance processing and inverse color matrix processing to the image signal subjected to the demosaicking processing.

9. An image processing method comprising:
holding one line of RAW image signals in a line memory;
transferring the RAW image signal from the line memory to a line buffer, as appropriate;
calculating a reference pixel that corresponds to an output pixel to be a correction object of distortion;
extracting a neighbor pixel necessary to calculate a pixel value of the reference pixel;
subjecting the extracted neighbor pixel to demosaicking processing using a color component of the output pixel, using the RAW image signal stored in the line buffer;
calculating a pixel value of the reference pixel using a pixel value of the neighbor pixel subjected to the demosaicking processing; and
outputting the pixel value of the reference pixel as a pixel value of the output pixel.

10. The image processing method according to claim 9, wherein correction of the distortion is performed on the output pixel in plurality adjoining having an identical color component in parallel.

11. The image processing method according to claim 9, wherein white balance processing and color matrix processing are performed for each pixel of the neighbor pixel.

12. The image processing method according to claim 11, wherein inverse white balance processing and inverse color matrix processing are performed on the reference pixel subjected to the demosaicking processing.

13. The image processing method according to claim 10, wherein the RAW image signal to calculate the output pixel in plurality is acquired from the line buffer at an identical cycle.

14. The image processing method according to claim 10, wherein white balance processing and color matrix processing are performed for each pixel of the neighbor pixel.

15. The image processing method according to claim 14, wherein inverse white balance processing and inverse color matrix processing are performed on the reference pixel that is calculated using the neighbor pixel subjected to the demosaicking processing.

16. An image processing apparatus comprising:
a line memory that holds one line of RAW image signals;
a line buffer that holds a plurality of lines of RAW image signals transferred from the line memory; and
a signal processing section that corrects distortion of the RAW image signal stored in the line buffer to generate a RAW output image signal, wherein
the signal processing section calculates a reference pixel corresponding to an output pixel, specifies a neighbor region to correct a pixel value of the reference pixel, and performs demosaicking processing of interpolating the pixel positioned in the neighbor region for a color component identical to a color component of the output pixel.

17. The image processing apparatus according to claim 16, wherein the signal processing section corrects the distortion of the output pixel in plurality adjoining that has an identical color component in parallel.

18. The image processing apparatus according to claim 16, wherein white balance processing and color matrix processing are performed for each pixel positioned in the neighbor region.

19. The image processing apparatus according to claim 18, wherein inverse white balance processing and inverse color matrix processing are performed on the reference pixel that is calculated using the neighbor pixel subjected to the demosaicking processing.

20. The image processing apparatus according to claim 17, wherein the RAW image signal to calculate the output pixel in plurality is acquired from the line buffer at an identical cycle.
